(19) United States
(12) Patent Application Publication
(10) Pub. No.: US 2026/0313517 A1
(43) Pub. Date: Oct. 8, 2026

(54) USER STATUS NOTIFICATION METHOD AND USER SUPPORT SYSTEM

(71) Applicant: TOYOTA JIDOSHA KABUSHIKI KAISHA, Aichi-ken (JP)

(72) Inventors: Yusuke FUKUI, Miyoshi-shi (JP); Leandro NICOSIA, Nakano-ku (JP)

(21) Appl. No.: 19/636,914

(22) Filed: Apr. 2, 2026

(30) Foreign Application Priority Data
Apr. 8, 2025 (JP) 2025-063631

(51) Int. Cl. H04W 40/30

(52) U.S. Cl. CPC H04W 40/30

(57) ABSTRACT

A user status notification method according to the present disclosure is executed by a computer. The user status notification method includes: obtaining a traffic situation on a planned travel route of a moving body operated by a user; based on the obtained traffic situation, generating communication availability information indicating whether or not the user is able to perform, via the moving body, communication with a supporter who supports the user; and displaying the generated communication availability information on a display device for the supporter. The communication availability information includes: current status information indicating whether or not the user is currently able to perform the communication; and future time information indicating when the user will be able to perform the communication if the user is currently unable to perform the communication.

### CROSS-REFERENCES TO RELATED APPLICATION

The present disclosure claims priority under 35 U.S.C. § 119 to Japanese Patent Application No. 2025-063631, filed on Apr. 8, 2025, which is incorporated herein by reference in its entirety.

### BACKGROUND

### Technical Field

The present disclosure relates to a technique for notifying a supporter of the status of a user operating a moving body.

### Background Art

JP 6368887 B1 discloses a method in which, before a caller makes a call on a mobile phone network or an Internet network, a call recipient notifies the caller in advance whether or not the call can be received. Whether the recipient is able to receive the call or not is determined based on the information on whether the recipient is able to receive a call or not, which is set by the recipient. If the recipient is able to receive the call, the call is made normally. If, on the other hand, the recipient is unable to receive the call, a message indicating that the call cannot be received is displayed on a mobile phone of the caller.

Furthermore, JP 7408765 B1 discloses a call management device that includes a display control unit that causes a terminal device to display information indicating other users who can make a call with the user of the terminal device. The display control unit causes a terminal device of the first user to display a time period in which the second user is able to make a call. JP4453579B2 discloses an in-vehicle telephone system that superimposes, on a voice call, an image of the area in front of a vehicle captured during a hands-free call and transmits the superimposed image to the other party for the hands-free call.

### SUMMARY

According to the technique described in JP 6368887 B1, the caller can understand whether or not a call is possible at the time of making the call, but cannot understand when the recipient (callee) will be able to make a call in the future.

The present disclosure has been made in view of the problem described above, and an object thereof is to provide a technique that allows a supporter who supports a user operating a moving body to easily understand when the user will be able to communicate, including in the future.

A user status notification method according to the present disclosure is executed by a computer. The user status notification method includes: obtaining a traffic situation on a planned travel route of a moving body operated by a user; based on the obtained traffic situation, generating communication availability information indicating whether or not the user is able to perform, via the moving body, communication with a supporter who supports the user; and displaying the generated communication availability information on a display device for the supporter. The communication availability information includes: current status information indicating whether or not the user is currently able to perform the communication; and future time information indicating when the user will be able to perform the communication if the user is currently unable to perform the communication.

A user support system according to the present disclosure includes a display device and one or more processors. The display device is configured to display information for a supporter who supports a user operating a moving body. The one or more processors are configured to: obtain a traffic situation on a planned travel route of the moving body; based on the obtained traffic situation, generate communication availability information indicating whether or not the user is able to perform communication with the supporter via the moving body; and display the generated communication availability information on the display device. The communication availability information includes: current status information indicating whether or not the user is currently able to perform the communication; and future time information indicating when the user will be able to perform the communication if the user is currently unable to perform the communication.

According to the present disclosure, the communication availability information of the user displayed on the display device for the supporter includes not only the current status information but also the future time information indicating when the user will be able to communicate if the user is not currently able to communicate. This allows the supporter to easily understand when the user operating the moving body will be able to communicate, including in the future.

### BRIEF DESCRIPTION OF THE DRAWINGS

FIG. 1 is a schematic diagram showing an example of a configuration of each of a user support system and a vehicle (moving body) according to an embodiment;

FIG. 2 is a flowchart showing an example of processing related to user status notification according to an embodiment;

FIG. 3 is a diagram showing a first display example of communication availability information according to an embodiment;

FIG. 4 is a diagram showing an example of additional user information according to an embodiment;

FIG. 5 is a diagram showing a traffic situation display displayed incidentally to the communication availability information according to an embodiment; and

FIG. 6 is a diagram showing a second display example of the communication availability information according to an embodiment.

### DETAILED DESCRIPTION

Embodiments of the present disclosure will be described with reference to the accompanying drawings.

### 1. System Configuration

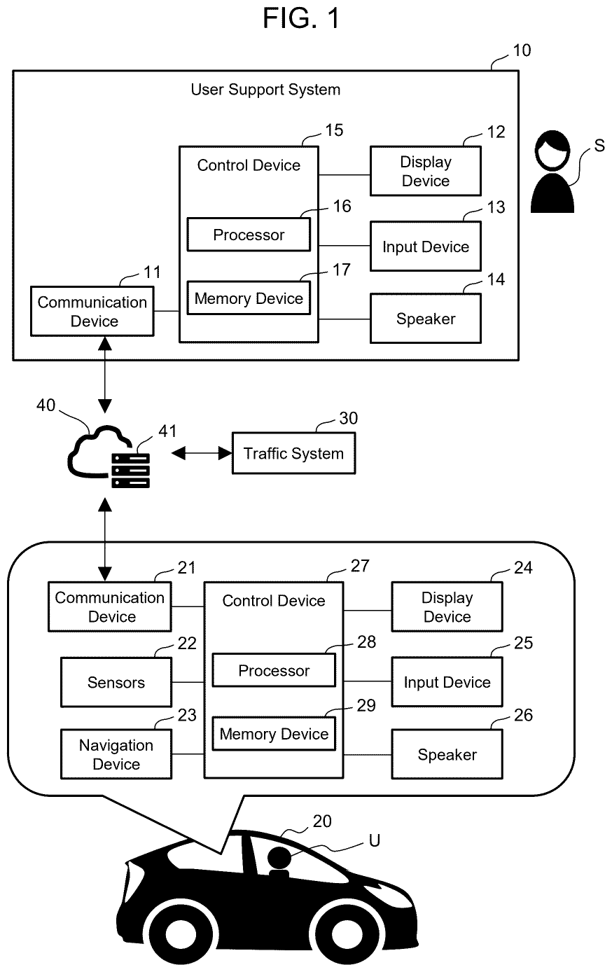

FIG. 1 is a schematic diagram showing an example of the configuration of each of a user support system 10 and a vehicle 20 according to the present embodiment. The user support system 10 is a system for remotely supporting a user U who operates a moving body. Examples of the moving body include a vehicle (e.g., an automobile), an aircraft, and the like. In the following description, the vehicle 20 is taken as an example of the moving body to which the user support system 10 is applied. When generalizing, the term “vehicle” in the following description should be read as “moving body”.

### 1-1. User Support System

The user support system 10 is operated by a supporter S (operator) who supports the user U. The supporter S is, for example, a concierge who responds to various requests (e.g., presenting recommended restaurants, making restaurant reservations) from the user U who operates the vehicle 20. The user support system 10 includes, for example, a communication device 11, a display device 12, an input device 13, a speaker 14, and a control device 15. The communication device 11, the display device 12, the input device 13, the speaker 14, and the control device 15 may be configured as a terminal device having a communication function, such as a smartphone or a personal computer.

The communication device 11 performs wireless communication with the outside of the user support system 10. Specifically, the communication device 11 performs wireless communication with each of one or more vehicles 20 and a traffic system 30. For example, the communication device 11 performs wireless communication with each of the one or more vehicles 20 and the traffic system 30 via an external server (e.g., a cloud 40). Alternatively, the communication device 11 may perform wireless communication directly with each of the one or more vehicles 20 and the traffic system 30. The cloud 40 includes, for example, a database 41 that stores various kinds of information used by the user support system 10 and the one or more vehicles 20 in connection with the support of the user U by the supporter S. The communication between the user support system 10 and the vehicle 20 includes communication (including telephone calls) between the supporter S and the user U via the user support system 10 and the vehicle 20.

The display device 12 displays various kinds of information necessary for the supporter S to support the user U. The input device 13 is used by the supporter S when the supporter S operates the user support system 10. Examples of the input device 13 include a touch panel, a keyboard, a mouse, buttons, a microphone, and the like. The speaker 14 is used together with the microphone when the supporter S makes a voice call with the user U of each vehicle 20.

The control device 15 controls the user support system 10. The control device 15 includes one or more processors 16 (hereinafter, simply referred to as a processor 16) and one or more memory devices 17 (hereinafter, simply referred to as a memory device 17). The processor 16 executes various kinds of processing related to the support provided by the supporter S to the user U. Examples of the processor 16 include a general purpose processor, a specific purpose processor, a central processing unit (CPU), a graphics processing unit (GPU), an application specific integrated circuit (ASIC), a field-programmable gate array (FPGA), and the like. The processor 16 may also be referred to as processing circuitry. The memory device 17 stores various kinds of information necessary for the various kinds of processing. Examples of the memory device 17 include a volatile memory, a non-volatile memory, a hard disk drive (HDD), a solid state drive (SSD), and the like. The functions of the control device 15 may be realized by cooperation between the processor 16 that executes a computer program and the memory device 17. The computer program is stored in the memory device 17. Alternatively, the computer program may be recorded in a non-transitory computer-readable recording medium or provided via a network.

### 1-2. Vehicle

The vehicle 20 is operated (driven) by a user U. The vehicle 20 includes a communication device 21, sensors 22, a navigation device 23, a display device 24, an input device 25, a speaker 26, and a control device 27.

The communication device 21 performs wireless communication with the outside of the vehicle 20. Specifically, the communication device 21 performs wireless communication with each of the user support system 10 and the traffic system 30. For example, the communication device 21 performs wireless communication with each of the user support system 10 and the traffic system 30 via an external server (e.g., the cloud 40). Alternatively, the communication device 21 may directly perform wireless communication with each of the user support system 10 and the traffic system 30.

The sensors 22 are equipped with the vehicle 20 and include, for example, a recognition sensor, a vehicle state sensor, and a position sensor. The recognition sensor (e.g., one or more cameras) recognizes (detects) the surroundings of the vehicle 20, including at least the area ahead of the vehicle 20. The vehicle state sensor detects the state of the vehicle 20 (e.g., vehicle speed, yaw rate, acceleration, steering angle). The position sensor detects the position and orientation of the vehicle 20.

The navigation device 23 generates a planned travel route R of the vehicle 20 based on, for example, information from the sensors 22 and the traffic system 30 as well as destination information received from the user U. The display device 24 displays various kinds of information for the user U. The various kinds of information includes information from the supporter S. The display device 24 is, for example, a head-up display (HUD) that displays information on the front windshield of the vehicle 20, or a display installed on the instrument panel. The input device 25 is used by the user U when the user U communicates with the supporter S. Examples of the input device 25 include a touch panel, buttons, a microphone, and the like. The speaker 26 is used together with the microphone when the user U makes a voice call with the supporter S.

The control device 27 controls the vehicle 20. The control device 27 includes one or more processors 28 (hereinafter, simply referred to as a processor 28) and one or more memory devices 29 (hereinafter, simply referred to as a memory device 29). The processors 28 execute various kinds of processing including processing related to communication (including phone calls) between the user U and the supporter S. Examples of the processor 28 include a general purpose processor, a specific purpose processor, a CPU, a GPU, an ASIC, an FPGA, and the like. The processor 28 may also be referred to as processing circuitry. The memory device 29 stores various kinds of information necessary for the various kinds of processing. Examples of the memory device 29 include a volatile memory, a non-volatile memory, an HDD, an SSD, and the like. The functions of the control device 27 may be realized by cooperation between the processor 28 that executes a computer program and the memory device 29. The computer program is stored in the memory device 29. Alternatively, the computer program may be recorded in a non-transitory computer-readable recording medium or provided via a network.

### 2. User Status Notification

The supporter S may operate the user support system 10 (input device 13) to attempt to perform communication (including phone calls) with the user U of the vehicle 20. More specifically, for example, when a request from the user U is received through communication from the user U, the supporter S may temporarily terminate the communication with the user U and then attempt to perform communication with the user U when the supporter S is ready to respond to the request. In addition, since the user U is currently operating the vehicle 20 (e.g., the user U is manually driving the vehicle 20), the user U may not be in an appropriate situation to respond to a call from the supporter S.

Accordingly, in the present embodiment, the user support system 10 notifies the supporter S of the status of the user U via the display device 12 in order to enable the supporter S to easily understand when the user U operating the vehicle 20 will be able to communicate, including in the future.

Specifically, the control device 15 (processor 16) obtains traffic situation information It for the planned travel route R of the vehicle 20 operated by the user U. Based on the obtained traffic situation information It, the control device 15 generates communication availability information Ic indicating whether or not the user U can communicate with the supporter S via the vehicle 20. Then, the control device 15 notifies the supporter S of the communication availability information Ic by displaying the generated communication availability information Ic on the display device 12.

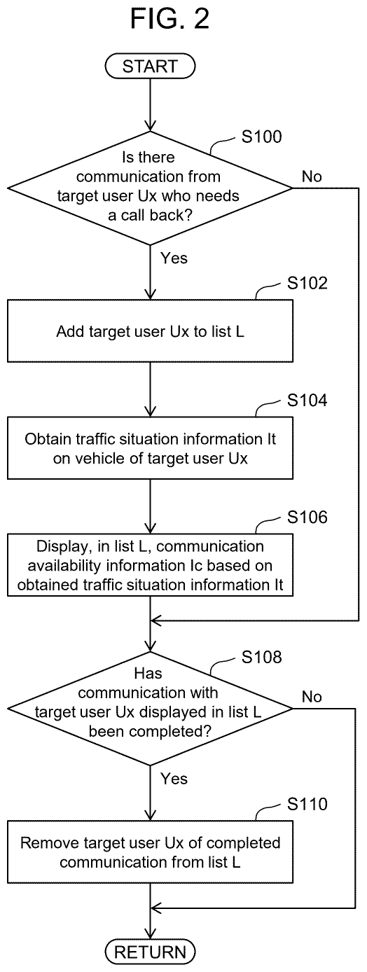

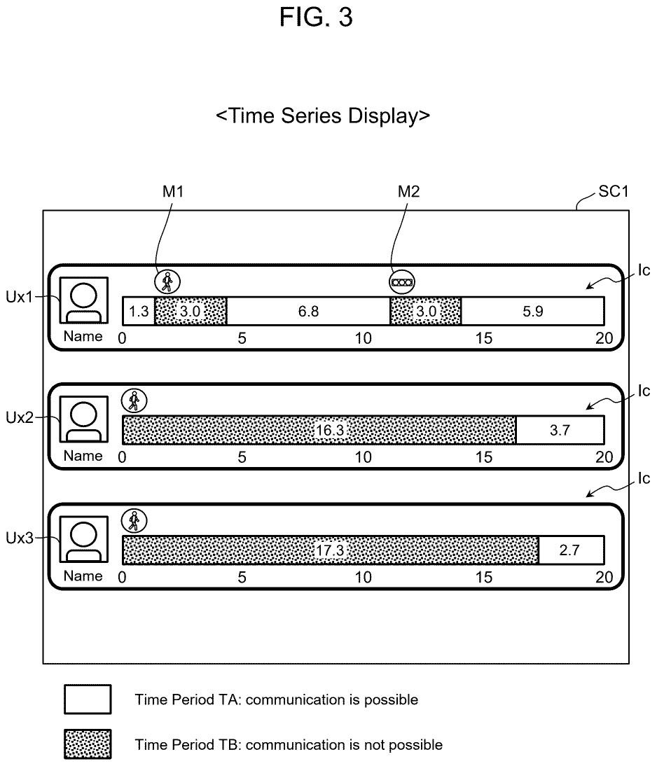

FIG. 2 is a flowchart showing an example of processing related to the user status notification according to the present embodiment. For example, the processing of this flowchart is repeatedly executed by the processor 16 of the user support system 10 at a predetermined cycle. More specifically, the processing of this flowchart is directed to notifying the user status of a plurality of users U. Further, the user status notification to the supporter S using the display device 12 is displayed on a screen SC1 of the display device 12 as a list L, for example, as shown in FIG. 3 described below. The information displayed in the list L is updated at, for example, the cycle of the processing of this flowchart.

In step S100, the processor 16 determines whether or not there is communication from a user U (hereinafter, referred to as a “target user Ux”) to whom the supporter S needs to return a call. As a result, when there is no communication from the target user Ux (step S100: No), the processing proceeds to step S108, which will be described below. On the other hand, when this kind of communication has occurred (step S100: Yes), the processing proceeds to step S102.

In step S102, the processor 16 adds, to the list L, information on the target user Ux with whom communication has been confirmed in step S100. For example, in step S102, first, personal information (e.g., face photo, name) that identifies the target user Ux is added to the list L. Thereafter, the processing proceeds to step S104.

In step S104, the processor 16 obtains traffic situation information It on the vehicle 20 (hereinafter, referred to as a target vehicle 20x) in which the target user Ux is riding. Specifically, in one example, the planned travel route R generated in each vehicle 20 is periodically transmitted to the cloud 40. Further, the cloud 40 periodically obtains, from the traffic system 30, the traffic situations in the area in which the user support system 10 provides the user support. The database 41 of the cloud 40 stores the planned travel routes R of the respective vehicles 20 in association with the traffic situations. The processor 16 obtains the traffic situations (traffic situation information It) of the planned travel route R of the target vehicle 20x from the cloud 40. It should be noted that the processor 16 may obtain (identify) traffic situation information It for the planned travel route R, based on the planned travel route R obtained directly from the target vehicle 20x and the traffic situations obtained directly from the traffic system 30.

In step S106 subsequent to step S104, the processor 16 displays, in the list L, the communication availability information Ic based on the obtained traffic situation information It.

Specifically, the processor 16 first generates communication availability information Ic based on the traffic situation information It. When the obtained traffic situation information It indicates that “there are no traffic situations that the target user Ux needs to be careful of while operating the target vehicle 20x”, the processor 16 generates communication availability information Ic indicating that the target user Ux can communicate with the supporter S. On the other hand, when the traffic situation information It indicates that “there is a traffic situation that the target user Ux needs to be careful of while operating the target vehicle 20x”, the processor 16 generates communication availability information Ic indicating that the target user Ux is not able to communicate with the supporter S. Examples of traffic situations that “the target user Ux needs to be careful of” include “there is a crosswalk on the planned route R”, “there is a pedestrian about to cross a crosswalk on the planned route R”, and “there is a traffic light on the planned route R that is about to turn red”. The processor 16 displays the generated communication availability information Ic in the list L displayed using the display device 12.

FIG. 3 is a diagram showing a first display example of the communication availability information Ic according to the present embodiment. FIG. 3 shows the display on the screen SC1 of the display device 12. In one example, in FIG. 3, the status of three target users Ux1 to Ux3 are shown as the list L. The display of each target user Ux includes a display of personal information (e.g., face photo, name) that identifies the target user Ux. Further, in the first display example, the display of the status of each target user Ux includes displaying, as the communication availability information Ic, a time period TA and a time periods TB in chronological order. The time period TA corresponds to a time period during which the target user Ux is able to perform the communication. The time period TB corresponds to a time period during which the target user Ux is unable to perform the communication. In addition, when generating the communication availability information Ic, the processor 16 allocates, to the time period TB, a time period in which there is a traffic situation on the planned travel route R that the target user Ux needs to be careful of.

More specifically, in the time series display shown in FIG. 3, for example, each of the time periods TA and TB is displayed as a long and thin bar with a time axis display (e.g., elapsed time displayed in 5-second intervals) indicating the current time as zero. The longer the time period, the longer the bars are displayed. Additionally, as shown in FIG. 3, each of the time periods TA and TB may be displayed with a number indicating the length of the time period. Also, as shown in FIG. 3, the display of the communication availability information Ic may include displaying one or more marks (e.g., a pedestrian mark M1, a traffic light mark M2) that visually represents the reason why the target user Ux is unable to communicate, in association with the time period TB.

Moreover, in FIG. 3, the currently available target user Ux1 is arranged at the top of the list L. Then, the target user Ux2 whose communicable time period TA arrives next earliest after the target user Ux1 is arranged one below the target user Ux1. Further, the target user Ux3 whose communicable time period TA arrives the latest is arranged at the bottom. As just described, the list L may be configured such that the earlier a target user Ux is available for communication (in other words, the higher the priority of response by the supporter S), the higher the target user Ux is displayed. In addition, when there are a plurality of target users Ux who are currently available for communication, the earlier a target user Ux has communicated to convey a request to the supporter S, the higher the target user Ux may be displayed.

Additionally, in the first display example, the first time period TA of the target user Ux1 and the time periods TB of the target users Ux2 and Ux3 each correspond to an example of the “current status information” according to the present disclosure. Also, the time periods TA of the target users Ux2 and Ux3 who are not currently available for communication each correspond to an example of the “future time information” according to the present disclosure.

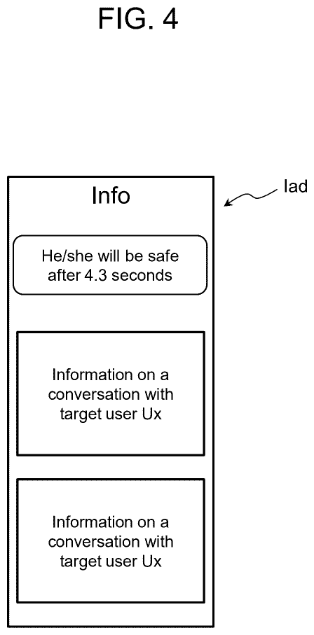

FIG. 4 is a diagram showing an example of additional user information Iad according to the present embodiment. The user information Iad shown in FIG. 4 is additional information about the target user Ux (Ux1 in FIG. 3) who has the highest priority of response by the supporter S. The user information Iad may be displayed near the information of the target user Ux on the list L, or may be displayed outside the list L. As shown in FIG. 4, the user information Iad may include text information indicating the time until the target user Ux becomes able to communicate (e.g., “He/she will be safe after 4.3 seconds”). Also, the user information Iad may include information on a conversation between the supporter S and the target user Ux. For example, the conversation information may be information indicating a request conveyed by the target user Ux to the supporter S (e.g., photos showing candidates for restaurants where the target user Ux wishes to make a reservation).

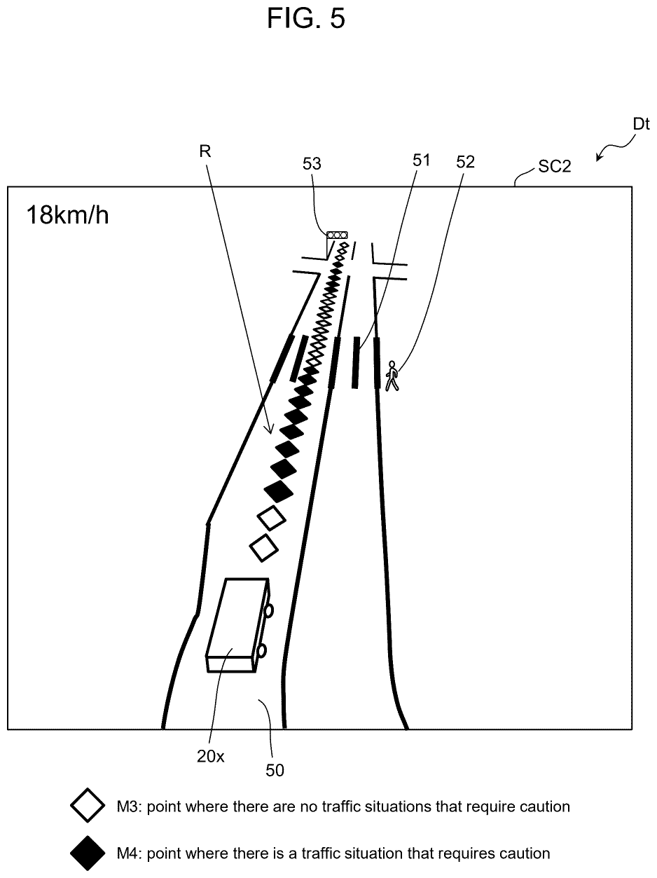

FIG. 5 is a diagram showing a traffic situation display Dt displayed incidentally to the communication availability information Ic according to the present embodiment. The display device 12 may include a screen SC2 that displays the traffic situation display Dt in conjunction with the list L (see, for example, FIG. 3) including the communication availability information Ic. The traffic situation display Dt includes a bird's-eye view image showing the current surroundings of the target vehicle 20x operated by the target user Ux. For example, this bird's-eye view image is generated by the cloud 40 from a plurality of images captured by a camera (e.g., a camera equipped with the vehicle 20 or an infrastructure camera) that captures the surroundings of the target vehicle 20x. The processor 16 displays the bird's-eye view image obtained from the cloud 40 on the screen SC2. The bird's-eye view image shown in FIG. 5 includes a road 50 on which the target vehicle 20x is traveling, a crosswalk 51 in front of the target vehicle 20x, a pedestrian 52 about to cross the crosswalk 51, and a traffic light 53 in front of the target vehicle 20x. The bird's-eye view image also includes marks M3 and M4 indicating respective points on the planned travel route R of the target vehicle 20x. The mark M3 indicates a point where there are no traffic situations that the target user Ux needs to be careful of (i.e., a point corresponding to the time period TA during which communication is possible). On the other hand, the mark M4 indicates a point where there is a traffic situation that the target user Ux needs to be careful of (i.e., a point corresponding to the time period TB during which communication is not possible). Whether the mark at each point is the mark M3 or the mark M4 is determined based on the traffic situation information It for the planned travel route R. The time periods TA and TB described above are identified based on, for example, the information on the mark M3 or M4 at each point and the position information and speed information on the target vehicle 20x obtained from the target vehicle 20x via the cloud 40. The speed information on the target vehicle 20x may be displayed on the bird's-eye view image in a superimposed manner as shown in FIG. 5. By using this kind of traffic situation display Dt, the supporter S operating the user support system 10 can more easily understand when the target user Ux operating the target vehicle 20x will be able to communicate, including future times.

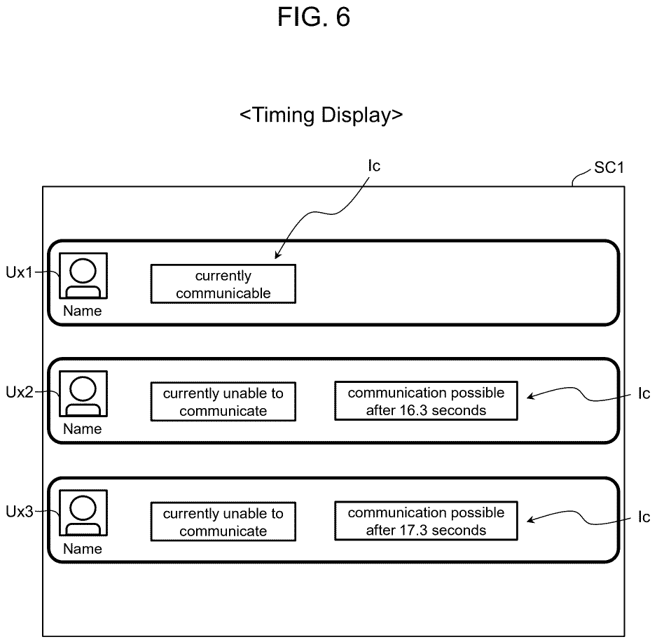

FIG. 6 is a diagram showing a second display example of the communication availability information Ic according to the present embodiment. The second display example is different from the first display example in the following points.

In the second display example, for the currently communicable target user Ux1, the current status information (e.g., a text message) indicating that communication is currently possible is displayed as the communication availability information Ic. In other words, the display of the current status information in the second display example indicates that the timing when communication with the target user Ux1 is possible is the current time. On the other hand, for each of the target users Ux2 and Ux3 who are currently unable to communicate, the future time information (e.g., the time until communication will be possible) indicating when communication will be possible is displayed, as the communication availability information Ic, along with the current status information (e.g., a text message) indicating that communication is currently impossible. In FIG. 6, “communication possible after 16.3 seconds” and “communication possible after 17.3 seconds” are shown as examples of this future time information. In other words, the display of the future time information in the second display example indicates the future timing when communication with each of the target users Ux2 and Ux3 will be possible. Another example of the future time information may be the time when the target user Ux will be able to communicate. For example, the time may be displayed in the list L together with the current time.

In FIG. 2, in step S108 subsequent to step S106, the processor 16 determines whether or not the communication with the target user Ux displayed in the list L has been completed. When the supporter S communicates with a target user Ux who needs to be called back, the communication with the target user Ux is completed. When the communication is completed (step S108: Yes), the processor 16 removes the target user Ux of the completed communication from the list L (step S110). On the other hand, when no communication has been completed (step S108: No), the processing proceeds to RETURN.

### 3. Effect

As described above, according to the present embodiment, the communication availability information Ic on the target user Ux displayed on the display device 12 for the supporter S includes not only the “current status information” but also the “future time information” indicating when the target user Ux will be able to communicate if the target user Ux is not currently able to communicate. This allows the supporter S to easily understand when the target user Ux operating the target vehicle 20x will be able to communicate, including in the future. In addition, the display of the communication availability information Ic according to the present embodiment makes it possible to easily visualize the future safety of one or more target users (drivers) Ux who are the communication destinations of the supporter S.

Moreover, as shown as an example in FIG. 3, the display of the communication availability information Ic may be a time series display of one or more time periods TA during which communication is possible and one or more time periods TB during which communication is not possible. This allows the supporter S to easily visually confirm when communication with each target user Ux becomes possible.

Furthermore, according to the present embodiment, when the communication availability information Ic is generated, a time period during which there is a traffic situation on the planned travel route R that the target user Ux needs to be careful of may be allocated to the time period TB during which the target user Ux is unable to perform the communication. This allows the supporter S to attempt to communicate with the target user Ux at an appropriate time that does not interfere with the operation of the target vehicle 20x by the target user Ux.

What is claimed is:

1. A user status notification method executed by a computer, the user status notification method comprising:
obtaining a traffic situation on a planned travel route of a moving body operated by a user;
based on the obtained traffic situation, generating communication availability information indicating whether or not the user is able to perform, via the moving body, communication with a supporter who supports the user; and
displaying the generated communication availability information on a display device for the supporter, wherein
the communication availability information includes:
current status information indicating whether or not the user is currently able to perform the communication; and
future time information indicating when the user will be able to perform the communication if the user is currently unable to perform the communication.

2. The user status notification method according to claim 1, wherein
the display of the communication availability information on the display device includes displaying, in chronological order, one or more time periods during which the user is able to perform the communication and one or more time periods during which the user is unable to perform the communication.

3. The user status notification method according to claim 2, wherein
the generation of the communication availability information includes allocating one or more time periods during which there is a traffic situation on the planned travel route that the user needs to be careful of, to the one or more time periods during which the user is unable to perform the communication.

4. The user status notification method according to claim 1, further comprising
in response to the supporter communicating with a target user who needs a call back, executing the display of the communication availability information on the display device for the target user.

5. A user support system comprising:
a display device configured to display information for a supporter who supports a user operating a moving body; and
processing circuitry configured to:
obtain a traffic situation on a planned travel route of the moving body;
based on the obtained traffic situation, generate communication availability information indicating whether or not the user is able to perform communication with the supporter via the moving body; and
display the generated communication availability information on the display device, wherein
the communication availability information includes:
current status information indicating whether or not the user is currently able to perform the communication; and
future time information indicating when the user will be able to perform the communication if the user is currently unable to perform the communication.
